(19) United States
(12) Patent Application Publication
(10) Pub. No.: US 2009/0078820 A1
(43) Pub. Date: Mar. 26, 2009

(54) WING-TO-BODY FAIRING

(75) Inventors: JUHN-SHYUE LIN, RENTON, WA (US); HERBERT L. HOFFMAN, SEATTLE, WA (US); GARY R. CHEWNING, WOODINVILLE, WA (US); MELVIN KOSANCHICK, WOODINVILLE, WA (US); HUGH POLING, SEATTLE, WA (US)

Correspondence Address: EVAN LAW GROUP LLC;AND THE BOEING COMPANY, 600 West Jackson Blvd., Suite 625, CHICAGO, IL, 60661, US

(73) Assignee: THE BOEING COMPANY, CHICAGO, IL (US)

(21) Appl. No.: 11/861,542

(22) Filed: Sep. 26, 2007

(51) Int. Cl. B64C 23/00; B64C 1/40; B64G 1/22

(52) U.S. Cl. 244/1 N; 244/158.1

(57) ABSTRACT

In one embodiment, a wing-to-body fairing for reducing noise due to wing-to-body fairing vibrations in at least one of an aircraft and a spacecraft comprises a honeycomb center comprising a cavity which is substantially filled with foam material.

### BACKGROUND

Spacecraft, aircraft, and other vehicles often experience substantial vibrations, noise, and fatigue in fairings and in particularly wing-to-body fairings which are attached between the wings and body of the spacecraft, aircraft, or vehicle. Some of the previous prior art devices may have involved heavy, complex, excessive part, and/or expensive noise and vibration dampening devices in an effort to attempt to reduce vibrations, noise, and fatigue. However, many of these prior art devices do not sufficiently reduce noise, vibration, and/or fatigue, and/or may lead to increased weight, increased complexity, an increased number of parts, an increased cost, and/or experience other types of issues.

A wing-to-body fairing, and a method of use thereof, is needed to decrease one or more problems associated with one or more of the existing wing-to-body fairings and/or methods of use thereof.

### SUMMARY

In one aspect of the disclosure, a fairing for reducing noise due to fairing vibrations in at least one of an aircraft and a spacecraft comprises a honeycomb center comprising a cavity which is substantially filled with foam material, and a plurality of layers surrounding the honeycomb center. The fairing may comprise a wing-to-body fairing, sometimes also called wing to fuselage or fillet panels.

In another aspect of the disclosure, a method of reducing fairing vibrations in at least one of an aircraft and a spacecraft is provided. In one step, a wing-to-body fairing is provided comprising a honeycomb center having a cavity. In another step, the cavity is substantially filled with foam material. In an additional step, the honeycomb center is surrounded with a plurality of layers. In yet another step, the wing-to-body fairing is attached to a wing and a body of at least one of an aircraft and a spacecraft.

These and other features, aspects and advantages of the disclosure will become better understood with reference to the following drawings, description and claims.

### BRIEF DESCRIPTION OF THE DRAWINGS

FIG. 1 shows a bottom perspective view of one embodiment of a wing-to-body fairing attached between a body and wing of an aircraft;

FIG. 2 shows a bottom perspective view of the wing-to-body fairing of FIG. 1 separated from the aircraft;

FIG. 3 shows a cross-section view along line 3-3 of the embodiment of FIG. 2;

FIG. 4 shows a flowchart of one embodiment of a method of reducing wing-to-body fairing vibrations in at least one of an aircraft and a spacecraft;

FIG. 5 is a flow diagram of aircraft production and service methodology; and

FIG. 6 is a block diagram of an aircraft.

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims.

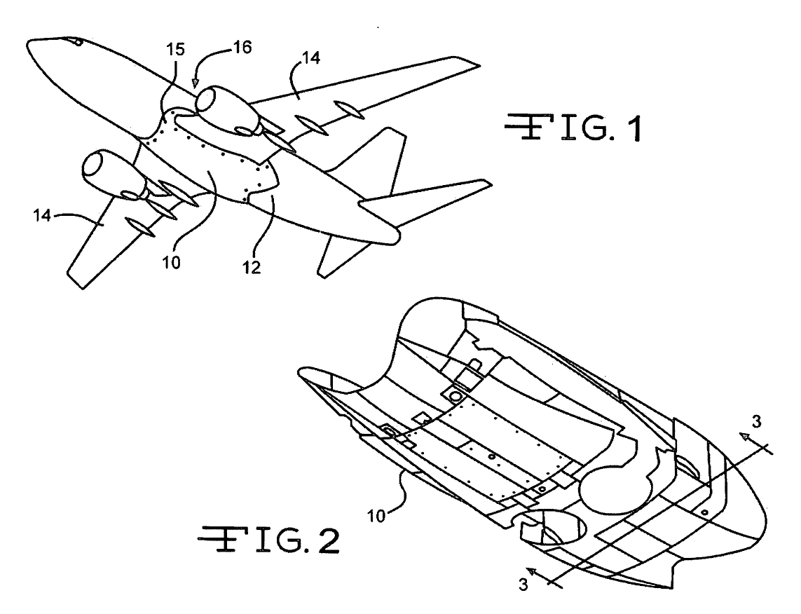

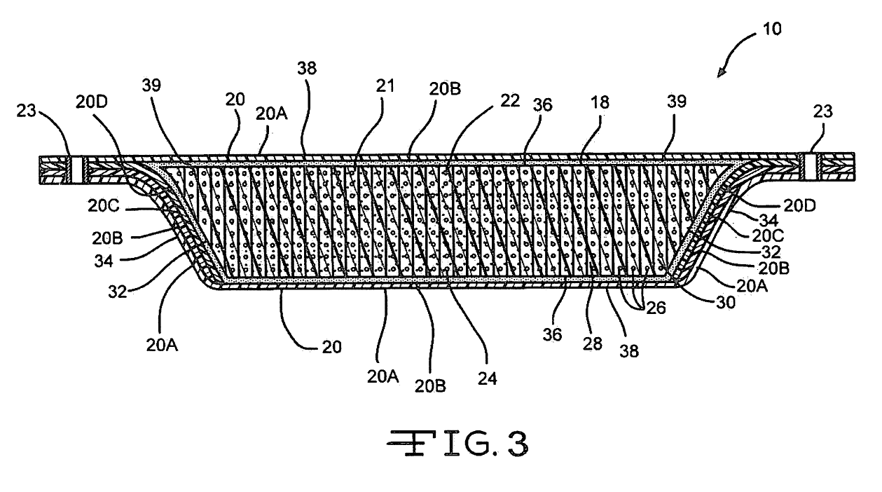

FIG. 1 shows a bottom perspective view of one embodiment of a wing-to-body fairing 10 attached between a body 12 and wing 14 of an aircraft 16. The wing-to-body fairing 10 may be attached between the wing 14 and body 12 utilizing fasteners 15 and other attachment mechanisms. The aircraft 16 may comprise a plane, spacecraft, and/or other type of vehicle. FIG. 2 shows a bottom perspective view of the wing-to-body fairing 10 of FIG. 1 separated from the aircraft 16. FIG. 3 shows a cross-section view along line 3-3 of the embodiment of FIG. 2.

As shown in FIG. 3, the wing-to-body fairing 10 may comprise a honeycomb center 18 sandwiched between a plurality of layers 20 which surround the honeycomb center 18. The honeycomb center 18 may comprise a Normex honeycomb core 21. The core 21 may be defined by a cavity 22. The cavity 22 may comprise an open cell pattern 24 defined by a plurality of holes 26 which lead into the cavity 22. The cavity 22 may be substantially filled with foam material 28. In order to have filled the cavity 22 with the foam material 28, a liquid 30 may have been substantially filled into the cavity 22 through the holes 26. The liquid 30 within the cavity 22 may have expanded into the foam material 28. The liquid 30 may comprise, without limitation, Polymeric Methylene Diphenyl Dissocyanate, while the foam material 28 may comprise Polyuthethane. In other embodiments, the liquid 30 and foam material 28 may comprise varying materials. In still other embodiments, the honeycomb center 18 may comprise varying types, sizes, materials, configurations, and orientations.

The honeycomb center 18 may be in the shape of the wing-to-body fairing 10. The plurality of layers 20 surrounding the honeycomb center 18 may be made of Fiberglass or other materials. Cylindrical bushing inserts 23 may extend between the plurality of layers 20 to provide additional support. Four layers 20A, 20B,.20C, and 20D may surround a curved and/or angled portion 32 of the honeycomb center 18 to form a curved and/or angled portion 34 of the wing-to-body fairing 10. Two layers 20A and 20B may surround a linear portion 36 of the honeycomb center 18 to form a linear portion 38 of the wing-to-body fairing 10. In other embodiments, between two to five layers 20 may surround various portions of the honeycomb center 18. In still other embodiments, any number of layers 20 may surround differing portions of the honeycomb center 18. The honeycomb center 18 may be attached to the plurality of layers 20 utilizing glue 39, another type of adhesive, or other attachment mechanism.

The wing-to-body fairing 10 substantially filled with foam material 28 may be used to reduce cabin noise due to vibrations between the body 12 and wing 14 of the aircraft 16 by providing a fairing 10 which is more resistant to vibration and noise. The wing-to-body fairing 10 substantially filled with foam material 28 may reduce noise/vibrations effectively in the frequency range below 400 Hz. The wing-to-body fairing 10 substantially filled with foam material 28 may further reduce fatigue by providing a fairing 10 which is more fatigue resilient. In other embodiments, the wing-to-body fairing 10 substantially filled with foam material 28 may be used to reduce noise, to reduce vibration, and/or to reduce fatigue in another type of vehicle such as a spacecraft. Embodiments may be used in the fabrication of fairings other than the wing-to-fuselage fairing, such as in other areas where noise, fatigue, and vibration may be reduced.

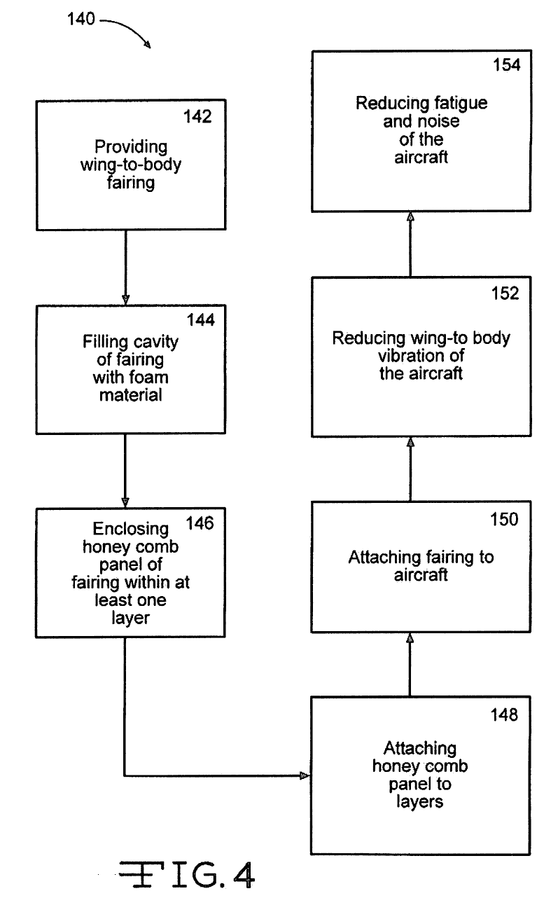

FIG. 4 is a flowchart showing one embodiment of a method 140 of reducing wing-to-body fairing vibrations in at least one of an aircraft and a spacecraft 16. In one step 142, a wing-to-body fairing 10 may be provided comprising a honeycomb center 18 comprising a core 21 defined by a cavity 22. The cavity 22 may comprise an open cell pattern 24 defined by a plurality of holes 26 which lead into the cavity 22. The wing-to-body fairing 10 may be at least partially curved and/or angled. The wing-to-body fairing 10 may comprise a plurality of layers 20 which may be made of Fiberglass or other materials. In one embodiment, between two to five layers 20 may be utilized. In other embodiments, varying numbers of layers 20 may be used. In still other embodiments, the wing-to-body fairing 10 may comprise any of the embodiments disclosed herein.

In another step 144, the cavity 22 may be substantially filled with foam material 28. Step 144 may comprise substantially filling liquid 30 into the cavity 22 through the holes 26 and expanding the liquid 30 into foam material 28. The liquid 30 may comprise Polymeric Methylene Diphenyl Dissocyanate, while the foam material 28 may comprise Polyuthethane. In other embodiments, the liquid 30 and foam material 28 may comprise varying materials. In still another step 146, the honeycomb center 18 may be enclosed within at least one layer 20, also called face sheets. In an additional step 148, the honeycomb center 18 may be attached to the at least one layer 20 or ply utilizing glue, adhesive, or other attachment mechanisms. The layers 20 or plies may be arranged in varying ply orientations. For instance, 0, 30, 60, 90 and/or 0, 45, 90 and the at least one layer 20 may be made from material suitable for conveying the energy from a lightening strike from the fairing 10 to the surrounding structure. In yet another step 150, the wing-to-body fairing 10, also known as a wing to fuselage fairing, may be attached to a wing 14 and a body 12 of at least one of an aircraft and a spacecraft 16 utilizing adhesive, fastening, or another attachment mechanism.

In still another step 152, wing-to-body vibrations in the at least one aircraft and spacecraft 16 may be reduced due to the attached wing-to-body fairing 10 which is substantially filled with foam material 28. The wing-to-body vibrations which are reduced may have a frequency of less than 400 Hz. In other embodiments, the wing-to-body vibrations which are reduced may have varying frequencies. In yet another step 154, fatigue and noise in the at least one aircraft and spacecraft 16 may be reduced due to the attached wing-to-body fairing which is substantially filled with foam material 28.

One or more embodiments of the disclosure may reduce and/or eliminate one or more problems of one or more of the existing fairings, and in particular the wing-to-body fairing, and/or methods of use. For instance, one or more embodiments of the disclosure may reduce wing-to-body fairing vibrations, noise, and/or fatigue as a result of using the foam-filled honeycomb center 18.

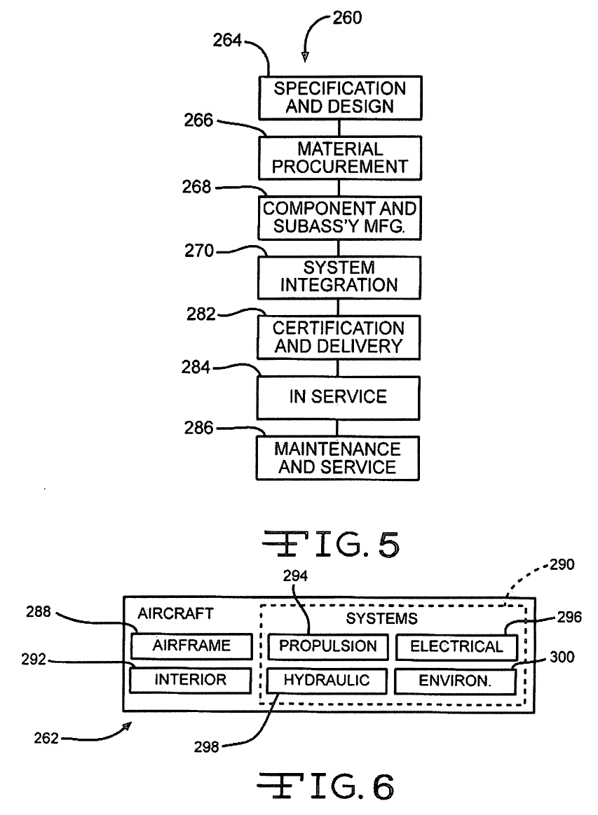

Referring more particularly to the drawings, embodiments of the disclosure may be described in the context of an aircraft manufacturing and service method 260 as shown in FIG. 5 and an aircraft 262 as shown in FIG. 6. During pre-production, exemplary method 260 may include specification and design 264 of the aircraft 262 and material procurement 266. During production, component and subassembly manufacturing 269 and system integration 270 of the aircraft 262 takes place. Thereafter, the aircraft 262 may go through certification and delivery 282 in order to be placed in service 284. While in service by a customer, the aircraft 262 is scheduled for routine maintenance and service 286 (which may also include modification, reconfiguration, refurbishment, and so on).

Each of the processes of method 260 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 6, the aircraft 262 produced by the exemplary method 260 may include an airframe 288 with a plurality of systems 290 and an interior 292. Examples of high-level systems 290 include one or more of a propulsion system 294, an electrical system 296, a hydraulic system 298, and an environmental system 300. Any number of other systems may be included. Although an aerospace example is shown, the principles of the invention may be applied to other industries, such as the automotive industry.

Apparatus and methods embodied herein may be employed during any one or more of the stages of the production and service method 260. For example, components or subassemblies corresponding to production process 268 may be fabricated or manufactured in a manner similar to components or subassemblies produced while the aircraft 262 is in service. Also, one or more apparatus embodiments, method embodiments, or a combination thereof may be utilized during the production stages 268 and 270, for example, by substantially expediting assembly of or reducing the cost of an aircraft 262. Similarly, one or more apparatus embodiments, method embodiments, or a combination thereof may be utilized while the aircraft 262 is in service, for example and without limitation, to maintenance and service 286.

It should be understood, of course, that the foregoing relates to exemplary embodiments of the disclosure and that modifications may be made without departing from the spirit and scope of the disclosure as set forth in the following claims.

1. A fairing for reducing noise due to fairing vibrations in at least one of an aircraft and a spacecraft comprising:
a honeycomb center comprising a cavity which is substantially filled with foam material; and
a plurality of layers surrounding the honeycomb center.

2. The fairing of claim 1 wherein the fairing is a wing-to-body fairing.

3. The fairing of claim 1 wherein the honeycomb center further comprises a plurality of holes, a liquid was substantially filled into the cavity through the holes, and the liquid expanded into the foam material.

4. The fairing of claim 3 wherein the liquid comprises Polymeric Methylene Diphenyl Diisocyanate and the foam material comprises Polyuthethane.

5. The fairing of claim 1 wherein the foam material comprises at least one of Polymeric Methylene Diphenyl Diisocyanate and Polyuthethane.

6. The fairing of claim 1 wherein the fairing is attached to at least one of an aircraft and a spacecraft.

7. The fairing of claim 1 wherein the fairing is further for reducing fatigue and noise in at least one of an aircraft and a spacecraft.

8. The fairing of claim 1 wherein the fairing attaches to a body and to a wing of at least one of an aircraft and a spacecraft.

9. The fairing of claim 1 wherein the reduces noise/vibrations in the frequency range of less than 400 Hz.

10. The fairing of claim 1 wherein the plurality of layers comprises Fiberglass layers.

11. The fairing of claim 1 wherein between two to five layers surround the honeycomb center.

12. The fairing of claim 1 wherein the fairing is at least one of angled and curved.

13. A method of reducing fairing vibrations in at least one of an aircraft and a spacecraft comprising:
providing a wing-to-body fairing comprising a honeycomb center having a cavity;
substantially filling said cavity with foam material;
surrounding the honeycomb center with a plurality of layers; and
attaching said wing-to-body fairing to a wing and a body of at least one of an aircraft and a spacecraft.

14. The method of claim 13 wherein the layers are made of Fiberglass.

15. The method of claim 13 wherein between two to five layers enclose the honeycomb center.

16. The method of claim 13 wherein the provided wing-to-body fairing is at least one of angled and curved.

17. The method of claim 13 further comprising the step of attaching the honeycomb center to the plurality of layers.

18. The method of claim 17 wherein the step of attaching the honeycomb center to the plurality of layers comprises adhering the honeycomb center to the plurality of layers.

19. The method of claim 13 wherein the honeycomb center further comprises a plurality of holes, and the step of substantially filling said cavity with the foam material comprises substantially filling liquid into the cavity through the holes, wherein the liquid expands into the foam material.

20. The method of claim 19 wherein the liquid comprises polymeric methylene diphenyl diisocyanate and the foam material comprises Polyuthethane.

21. The method of claim 13 wherein the foam material comprises at least one of Polymeric Methylene Diphenyl Diisocyanate and Polyuthethane.

22. The method of claim 13 wherein the step of attaching said wing-to-body fairing to the wing and to the body comprises at least one of adhering and fastening.

23. The method of claim 13 further comprising the step of reducing wing-to-body vibrations in said at least one aircraft and spacecraft due to said attached wing-to-body fairing.

24. The method of claim 23 wherein the wing-to-body vibrations which are reduced have a frequency of less than 400 Hz.

25. The method of claim 13 further comprising the step of reducing fatigue and noise in said at least one aircraft and spacecraft due to said attached wing-to-body fairing.
